(19) United States
(12) Patent Application Publication
(10) Pub. No.: US 2009/0179840 A1
(43) Pub. Date: Jul. 16, 2009

(54) DISPLAY DEVICE

(75) Inventors: Shinya Tanaka, Mie (JP); Hajime Imai, Mie (JP); Chikanori Tsukamura, Mie (JP); Yoshiharu Kataoka, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/375,069

(22) PCT Filed: Jun. 21, 2007
(86) PCT No.: PCT/JP2007/062535

§ 371 Date: Jan. 26, 2009

(30) Foreign Application Priority Data
Jul. 27, 2006 (JP) 2006-205211

(51) Int. Cl. G09G 3/36

(52) U.S. Cl. 345/87

(57) ABSTRACT

In a display device, a first glass substrate is curved. When signal line driving elements and scanning line driving elements are viewed from a normal direction of a principal surface of the first glass substrate, the signal line driving elements and the scanning line driving elements each have a rectangular or substantially rectangular shape with two longer sides and two shorter sides. The signal line driving elements and the scanning line driving elements are mounted so that the longer sides thereof are parallel or substantially parallel to one another.

### BACKGROUND OF THE INVENTION

1. Field of the Invention

The present invention relates to a display device, and more particularly to a display device having a curved shape.

2. Description of the Related Art

Generic display devices have substantially planar or rectangular solid shapes. However, in a display device having such a shape, external light in the surroundings may be reflected by a glass substrate, so that the surrounding landscapes may appear as reflection glares overlaid on a video on the display device, thus causing a misperception of the video. Therefore, adopting a curved shape for the display device is known to suppress reflection glares. In a display device of a curved shape, the glass substrate is curved in a predetermined shape (see, for example, Japanese Laid-Open Patent Publication No. 11-38395).

Generally speaking, an active matrix substrate that is used for a display device such as a liquid crystal display device includes a plurality of semiconductor chips (driving elements) which are mounted in a terminal region of a glass substrate. The semiconductor chips generate data signals and gate signals which are generated based on input signals, and supply these signals to signal lines and scanning lines. In the following descriptions of the present specification, a semiconductor chip which supplies a data signal to a signal line will be referred to as a signal line driving element, whereas a semiconductor chip which supplies a gate signal to a scanning line will be referred to as a scanning line driving element.

### SUMMARY OF THE INVENTION

The inventors of the invention described in the present application have discovered that, when signal line driving elements and scanning line driving elements are simply mounted on a curved glass substrate, the signal line driving elements and scanning line driving elements may become detached from the glass substrate due to a load which emanates from bending stress.

Preferred embodiments of the present invention have been developed in view of the above problems, and provide a display device having a curved shape, to prevent once-mounted signal line driving elements and scanning line driving elements from being detached from a glass substrate.

A display device according to a preferred embodiment of the present invention includes an active matrix substrate and a display medium layer disposed on a principal surface of the active matrix substrate, wherein, the active matrix substrate includes: a glass substrate having a principal surface which includes a displaying region and a terminal region, a plurality of circuit elements provided in the displaying region of the glass substrate, a plurality of signal lines and a plurality of scanning lines connected to the plurality of circuit elements, at least one signal line driving element mounted in the terminal region of the glass substrate to supply a data signal to the plurality of signal lines, and at least one scanning line driving element mounted in the terminal region of the glass substrate to supply a gate signal to the plurality of scanning lines; the glass substrate is curved; and when the at least one signal line driving element and the at least one scanning line driving element are each viewed from a normal direction of the principal surface of the glass substrate, the at least one signal line driving element and the at least one scanning line driving element each have a rectangular or substantially rectangular shape with two longer sides and two shorter sides, the at least one signal line driving element and the at least one scanning line driving element each being mounted so that the longer sides thereof are parallel or substantially parallel to one another.

In one preferred embodiment of the present invention, the glass substrate is curved in a direction which is perpendicular or substantially perpendicular to each longer side of the at least one signal line driving element.

In one preferred embodiment of the present invention, the longer sides of the at least one signal line driving element are parallel or substantially parallel, or perpendicular or substantially perpendicular, to a direction in which the plurality of signal lines extend.

In one preferred embodiment of the present invention, the principal surface of the glass substrate is curved in a concave shape.

In one preferred embodiment of the present invention, the principal surface of the glass substrate is curved in a convex shape.

In one preferred embodiment of the present invention, the at least one signal line driving element and the at least one scanning line driving element are each mounted via an anisotropic electrically-conductive layer.

In one preferred embodiment of the present invention, the active matrix substrate further includes a plurality of substrate lines provided in the terminal region of the glass substrate; input bumps and output bumps are provided on the at least one signal line driving element; and the plurality of substrate lines include a plurality of input substrate lines electrically connected to the input bumps of the at least one signal line driving element and a plurality of output substrate lines electrically connected to the plurality of signal lines and the output bumps of the at least one signal line driving element, the output substrate line or lines corresponding to the at least one signal line driving element being disposed so as to be closer to the displaying region than are the input substrate lines.

In one preferred embodiment of the present invention, the display device also includes a counter substrate opposing the active matrix substrate via the display medium layer, wherein, the display medium layer is a liquid crystal layer.

In one preferred embodiment of the present invention, the display device also includes a circuit arranged to receive a television broadcast.

In an automotive vehicle according to another preferred embodiment of the present invention, the display device according to one of the above-described preferred embodiments is used as an instrument panel.

According to various preferred embodiments of the present invention, in a display device having a curved shape, once-mounted signal line driving elements and scanning line driving elements can be prevented from being detached from a glass substrate.

Other features, elements, steps, characteristics and advantages of the present invention will become more apparent from the following detailed description of preferred embodiments of the present invention with reference to the attached drawings.

### BRIEF DESCRIPTION OF DRAWINGS

FIG. 1A is a schematic cross-sectional view of a display device according to a preferred embodiment of the present invention, FIG. 1B is a schematic side view of the display device of the present preferred embodiment, and FIG. 1C is a schematic plan view of the display device of the present preferred embodiment.

FIG. 2 is a schematic plan view of a display device of a comparative example.

FIG. 3 is a schematic plan view of a signal line driving element in the display device of the present preferred embodiment.

FIG. 4 is a diagram showing an example where the display device of the present preferred embodiment is used for an instrument panel.

FIG. 5 is a schematic plan view showing another variant of the display device of the present preferred embodiment.

FIG. 6 is a schematic plan view showing still another variant of the display device of the present preferred embodiment.

FIG. 7A is a schematic side view of still another display device of the present preferred embodiment, and FIG. 7B is a schematic plan view of the display device shown in FIG. 7A.

### DETAILED DESCRIPTION OF PREFERRED EMBODIMENTS

Hereinafter, preferred embodiments of a display device according to the present invention will be described with reference to the drawings. Herein, a liquid crystal display device will be illustrated as an example of a display device.

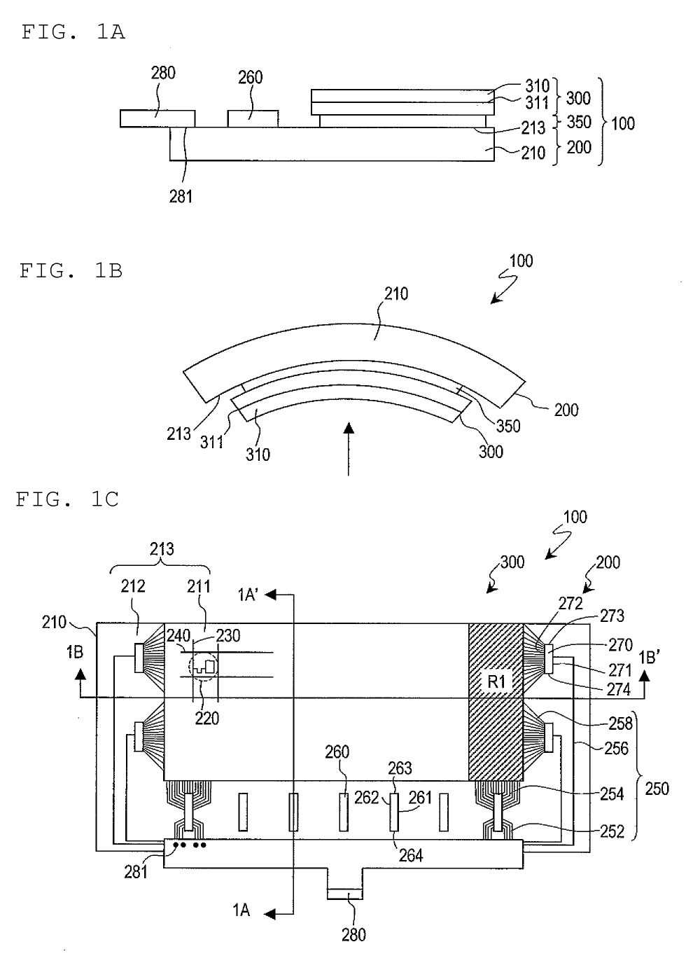

As shown in FIG. 1A, the display device 100 of the present preferred embodiment includes an active matrix substrate 200, a counter substrate 300, and a display medium layer 350 interposed between the active matrix substrate 200 and the counter substrate 300. As shown in FIG. 1B, the display device 100 of the present preferred embodiment has a curved shape. Herein, the display device 100 preferably is a liquid crystal display device, and the display medium layer 350 preferably is a liquid crystal layer. In this case, an image is displayed when each pixel modulates the light which is emitted from a backlight (not shown).

As shown in FIG. 1C, the active matrix substrate 200 includes: a glass substrate 210 having a principal surface 213 which includes a displaying region 211 and a terminal region 212; a plurality of circuit elements 220 provided in the displaying region 211 of the glass substrate 210; a plurality of signal lines 230 and a plurality of scanning lines 240 connected to the plurality of circuit elements 220; signal line driving elements 260 arranged to supply data signals to the signal lines 230; and scanning line driving elements 270 arranged to supply gate signals to the scanning lines 240. The signal line driving elements 260 and the scanning line driving elements 270 preferably are bare chips, for example. The signal line driving elements 260 and the scanning line driving elements 270 are mounted in the terminal region 212 of the glass substrate 210. Moreover, an input substrate 280 having a plurality of terminals 281 is attached in the terminal region 212 of the glass substrate 210.

FIG. 1A corresponds to a cross section along line 1A-1A′ in FIG. 1C. As shown in FIG. 1A, the counter substrate 300 includes a glass substrate 310. The area of the principal surface 213 of the glass substrate 210 is greater than that of the principal surface 311 of the glass substrate 310, and the glass substrate 310 is disposed so as to overlap the glass substrate 210. Note that, in the following descriptions of the present specification, the glass substrate 210 of the active matrix substrate 200 may be referred to as a “first glass substrate”, whereas the glass substrate 310 of the counter substrate 300 may be referred to as a “second glass substrate”.

FIG. 1B corresponds to a cross section along line 1B-1B′ in FIG. 1C. The arrow shown in FIG. 1B indicates a direction in which a viewer of the display device 100 watches the display surface. The first glass substrate 210 and the second glass substrate 310 are curved with respect to a bending axis which is parallel to the signal lines 230, in a direction that the scanning lines 240 extend, i.e., the lateral direction. As shown in FIG. 1B, the principal surface 213 of the first glass substrate 210 is curved in a concave shape, whereas the principal surface 311 of the second glass substrate 310 is curved in a convex shape, such that the principal surface 311 of the second glass substrate 310 is parallel or substantially parallel to the principal surface 213 of the first glass substrate 210. For example, the first glass substrate 210 preferably has an outer size of approximately 383.8 mm×122 mm; the second glass substrate 310 has an outer size of approximately 373.8 mm×116.5 mm; and the first and second glass substrates 210 and 310 preferably have a thickness of about 0.25 mm, for example. Moreover, radii of curvature of the first and second glass substrates 210 and 310 preferably are about 600 R to about 1500 R (about 600 mm to about 1500 mm), for example; herein, radii of curvature of the first and second glass substrates 210 and 310 are preferably about 1000 R.

In the displaying region 211, the signal lines 230 and the scanning lines 240 are disposed so that they cross each other perpendicularly. FIG. 1C shows two signal lines 230 and two scanning lines 240 as an exemplification. Each circuit element 220 has a pixel electrode and a thin film transistor. Moreover, the signal line driving elements 260 and the scanning line driving elements 270 are mounted on the glass substrate 210 via an anisotropic electrically-conductive layer (not shown) . The anisotropic electrically-conductive layer is formed by using an anisotropic electrically-conductive film (ACF), anisotropic electrically-conductive paste (ACP), or the like.

When each signal line driving element 260 is viewed from the normal direction of the principal surface 213 of the first glass substrate 210, the signal line driving element 260 has a rectangular or substantially rectangular shape with two longer sides 261, 262 and two shorter sides 263, 264. Moreover, when each scanning line driving element 270 is viewed from the normal direction of the principal surface 213 of the first glass substrate 210, the scanning line driving element 270 has a rectangular or substantially rectangular shape with two longer sides 271, 272 and two shorter sides 273, 274. The signal line driving elements 260 and the scanning line driving elements 270 are mounted on the first glass substrate 210 so that the longer sides 261, 262, 271, 272 are parallel or substantially parallel to one another.

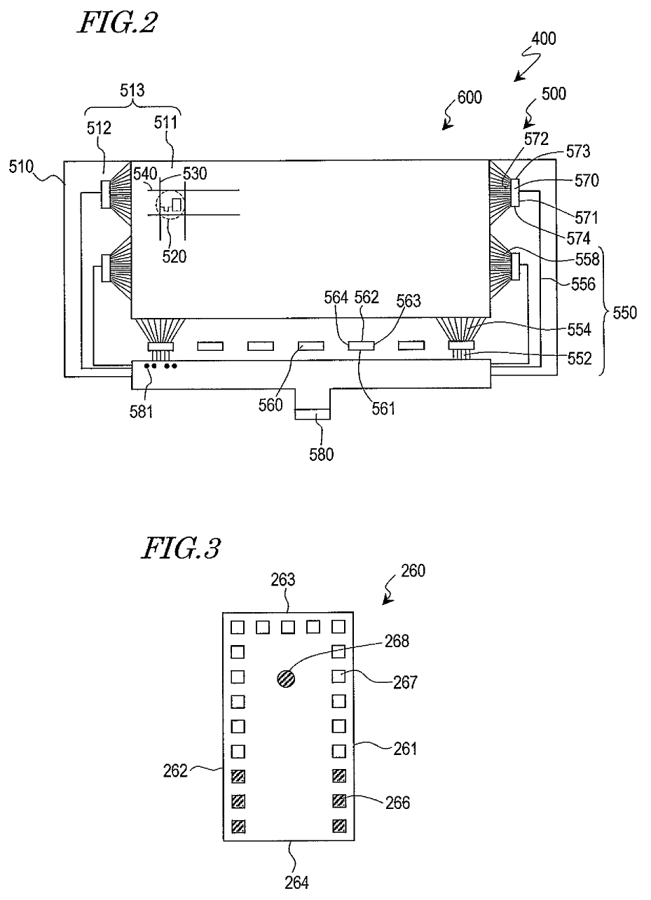

Hereinafter, the construction of the display device 100 of the present preferred embodiment will be described in comparison with that of the display device 400 of a comparative example. First, referring to FIG. 2, the construction of the display device 400 of the comparative example will be described.

A first glass substrate 510 and a second glass substrate are curved also in the display device 400 of the comparative example, as in the display device 100 of the present preferred embodiment. However, the display device 400 of the comparative example differs from the display device 100 of the present preferred embodiment in that longer sides 561, 562 of each signal line driving element 560 are parallel or substantially parallel to scanning lines 540. In the following descriptions of the present specification, when a signal line driving element 560 is disposed so that the longer sides 561, 562 of the signal line driving element 560 are parallel or substantially parallel to the scanning lines 540, as in the display device 400 of the comparative example, the signal line driving element may be referred to as being laterally positioned. On the other hand, as in the display device 100 of the present preferred embodiment, when a signal line driving element 260 is disposed so that the longer sides 261, 262 of the signal line driving element 260 are perpendicular or substantially perpendicular to the scanning lines 240 (i.e., parallel or substantially parallel to the signal lines 230), the signal line driving element may be referred to as being vertically positioned.

In the display device 400 of the comparative example, the signal line driving elements 560 are laterally positioned on the first glass substrate 510 which is curved in the lateral direction. Therefore, due to a bending stress, a load acts along the longer sides 561, 562 of the signal line driving elements 560 so as to detach it from the first glass substrate 510. In particular, a strong load acts on those signal line driving elements 560 which are at both ends of the row of signal line driving elements 560. If the signal line driving elements 560 are detached from a principal surface 513 of the first glass substrate 510, the connections between the signal line driving elements 560 and input substrate lines 552 and output substrate lines 554 will become insufficient.

On the other hand, in the display device 100 of the present preferred embodiment, as shown in FIG. 1B and FIG. 1C, the signal line driving elements 260 are vertically positioned on the first glass substrate 210 which is curved in the lateral direction. In this case, even if the first glass substrate 210 is curved, the signal line driving elements 260 are unlikely to be detached from the first glass substrate 210, and the electrical connection of the signal line driving elements 260 is ensured.

Thus, in the display device 100 of the present preferred embodiment, since the signal line driving elements 260 are vertically positioned, the electrical connection of the signal line driving elements 260 is ensured even if the first glass substrate 210 is curved in the lateral direction. Moreover, in the display device 100 of the present preferred embodiment, the longer sides 271, 272 of the scanning line driving elements 270 are also disposed parallel to the longer sides 261, 262 of the signal line driving elements 260, and thus the electrical connection of the scanning line driving elements 270 is ensured for a reason similar to that for the signal line driving elements 260.

Hereinafter, the construction of the signal line driving elements 260 in the display device 100 will be described. FIG. 3 shows a signal line driving element 260 as viewed from the normal direction of the principal surface 213 of the first glass substrate 210. The signal line driving element 260 has a rectangular or substantially rectangular shape having two longer sides 261, 262 and two shorter sides 263, 264, such that the ratio between the shorter sides 263, 264 and the longer sides 261, 262 is approximately 1:10, for example. Note that the scanning line driving elements 270 also have a similar construction to that of the signal line driving elements 260, such that, when viewed from the normal direction of the principal surface 213 of the first glass substrate 210, each scanning line driving element 270 has a rectangular or substantially rectangular shape having two longer sides 271, 272 and two shorter sides 273, 274. Moreover, the ratio between the shorter sides 273, 274 and the longer sides 271, 272 is substantially similar to that of the signal line driving elements 260. Note that, in strict manner, the ratio of the shorter sides and the longer sides may be different between the signal line driving elements 260 and the scanning line driving elements 270.

Input bumps 266 and output bumps 267 shown in FIG. 3 are provided on a surface of the signal line driving element 260 that opposes the principal surface 213 of the first glass substrate 210 (see FIG. 1A and FIG. 1C), and an integrated circuit 268 shown in FIG. 3 is incorporated inside the signal line driving element 260. Note that, as will be understood from FIG. 1C and FIG. 3, the input bumps 266 are disposed on the input substrate side so as to be connected to the input substrate lines 252 of the first glass substrate 210, whereas the output bumps 267 are disposed on the displaying region side so as to be connected to the output substrate lines 254 of the first glass substrate 210. In the signal line driving element 260, the number of output bumps 267 is greater than the number of input bumps 266. While FIG. 3 schematically shows the input bumps 266 and output bumps 267 provided on the signal line driving element 260, there may be 42 input bumps 266 and 480 output bumps 267, for example. Moreover, the interval between adjoining output bumps 267 preferably is about 36 μm, for example.

FIG. 1C is referred to again. A plurality of substrate lines 250 are provided in the terminal region 212 of the first glass substrate 210. The plurality of substrate lines 250 include: input substrate lines 252, which electrically connect terminals 281 of the input substrate 280 and the signal line driving elements 260; output substrate lines 254, which electrically connect the signal lines 230 and the signal line driving elements 260; input substrate lines 256, which electrically connect the terminals 281 of the input substrate 280 and the scanning line driving elements 270; and output substrate lines 258, which electrically connect the scanning lines 240 and the scanning line driving elements 270. In the following descriptions of the present specification, the input substrate lines 252 will be referred to as first input substrate lines; the output substrate lines 254 will be referred to as first output substrate lines; the input substrate lines 256 will be referred to as second input substrate lines; and the output substrate lines 258 will be referred to as second output substrate lines. Note that adjoining substrate lines 250 are spaced apart by a predetermined distance (e.g., about 31 μm), so as to be electrically insulated from each other.

Note that, although the first input substrate lines 252 and the first output substrate lines 254 are preferably provided for each signal line driving element 260, FIG. 1C only shows those corresponding to the signal line driving elements 260 that are provided at both ends of a row of signal line driving elements 260, in order to prevent the figure from becoming too complicated. Similarly, although the terminals 281 of the input substrate 280 are provided so as to be electrically connected to the respective first input substrate lines for each signal line driving element 260, FIG. 1C only shows those corresponding to the signal line driving element 260 at the left end, in order to prevent the figure from becoming too complicated.

Input signals are input from the terminals 281 of the input substrate 280 to the signal line driving elements 260 and the scanning line driving elements 270, respectively, via the first input substrate lines 252 and the second input substrate lines 256 provided in the terminal region 212 of the first glass substrate 210. An integrated circuit (see FIG. 3; not shown in FIG. 1C) is incorporated in each of the signal line driving elements 260 and the scanning line driving elements 270. Each integrated circuit performs a predetermined process based on an input signal to generate a data signal and a gate signal, and they supply the data signals and the gate signals to the signal lines 230 and the scanning lines 240 respectively via the first output substrate lines 254 and the second output substrate lines 258.

Moreover, as shown in FIG. 1C, in each of the plurality of signal line driving elements 260, the first output substrate lines 254 are provided so as to be closer to the displaying region than are the first input substrate lines 252. FIG. 1C shows a region R1 that accommodates signal lines 230 to which a data signal is supplied from a single signal line driving element 260. Each signal line driving element 260 is disposed near the center of a shorter side of the region R1, such that the first input substrate lines 252 and the first output substrate lines 254 are disposed axisymmetrically with respect to the signal line driving element 260. The first input substrate lines 252 and the first output substrate lines 254 have parallel portions which extend in parallel or substantially parallel to the longer sides 261, 262 of the signal line driving elements 260, and the parallel portions of the first input substrate lines 252 are disposed closer to the input substrate than are the parallel portions of the first output substrate lines 254, in a coinciding arrangement with them with respect to the lateral width of the first glass substrate 210.

Moreover, since the display device 100 of the present preferred embodiment has a curved shape, it is possible to suppress reflection glare as mentioned above. Moreover, the display device 100 of the present preferred embodiment has the following advantages in addition to suppression of reflection glare.

Since the display device has a curved shape, the display device has an improved design freedom, thus further broadening the range of applications for the display device. For example, the display device 100 is suitably used as a display device for an instrument panel to be incorporated in an automotive vehicle. As used herein, an “automotive vehicle” broadly refers to any vehicle or machine which is capable of self propulsion and used for passenger or article transportation or moving of objects, without being limited to so-called automobiles. Specifically, an instrument panel of an automobile may carry various instruments such as a speedometer. In the place of such instruments, a display device having a curved shape can be used. In recent years, there is a tendency that automobiles having a curved structure are preferred. By using a curved liquid crystal display device as an instrument panel, it becomes possible to produce an automobile which satisfies the preferences of users.

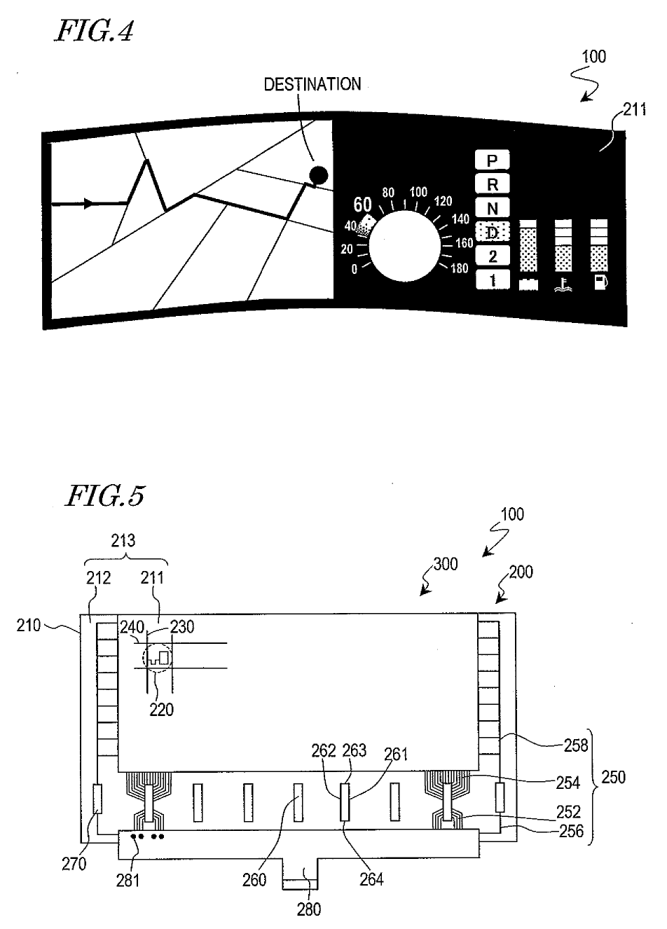

FIG. 4 shows an example where the display device 100 of the present preferred embodiment is used for an instrument panel of a four-wheeled automobile. FIG. 4 shows an example where the velocity, shift lever position, remaining battery power, water temperature, and remaining fuel amount of the automotive vehicle are displayed on the right-hand side of a displaying region 211, whereas car navigation information is displayed on the left-hand side of the displaying region 211. The car navigation information is information of a current location or a route to a destination for a driver during travel.

In addition to improvements in design freedom, since the display device 100 has a curved shape, differences in distances from the viewer to the central portion and peripheral portions on the display surface can be reduced, whereby an enhanced display realism is provided.

Moreover, a curved glass substrate can be produced by known methods as described below. For example, a glass substrate may be sandwiched by acrylic plates having a curved-surface shape, and a pressure may be applied so as to compress the two acrylic substrates, whereby a curved glass substrate can be produced. Alternatively, a glass substrate may be secured to an acrylic plate having a curved-surface shape, whereby a curved glass substrate can be produced.

Alternatively, the glass substrate may be curved by press forming. Specifically, after overlaying a second glass substrate on a first glass substrate, at a high temperature, they may be pressed with a concave shaping die and a convex shaping die having a predetermined radius of curvature, thus performing a press forming. Alternatively, after overlaying a second glass substrate on a first glass substrate, a self-weight forming may be performed at a high temperature, followed by a press forming.

The first glass substrate 210 may be curved after mounting the signal line driving elements 260 and scanning line driving elements 270 on the first glass substrate 210 having a planar shape, or, the signal line driving elements 260 and scanning line driving elements 270 may be mounted after curving the first glass substrate 210. However, mounting can be performed more easily by curving the first glass substrate 210 after mounting the signal line driving elements 260 and scanning line driving elements 270.

In the display device 100 shown in FIG. 1C, the scanning line driving elements 270 are preferably disposed so that the longer sides 272 oppose the displaying region 211; however, the present invention is not limited thereto. As shown in FIG. 5, the scanning line driving elements 270 may be disposed in the same row as the signal line driving elements 260. As a result, the lateral width of the first glass substrate 210, i.e., the lateral width of the active matrix substrate 200, can be reduced.

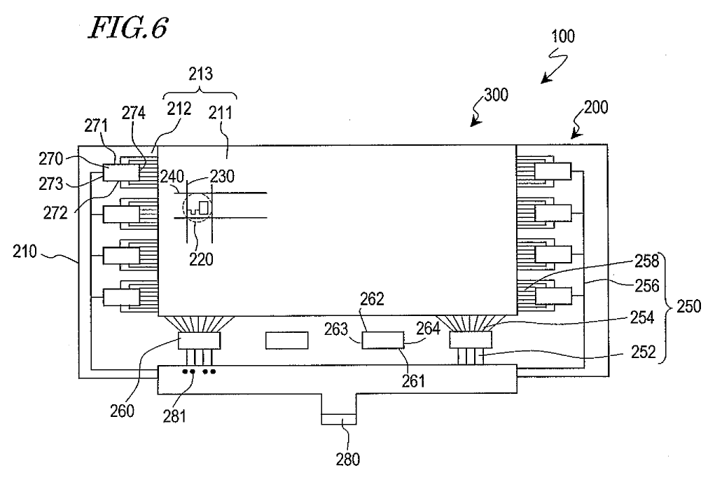

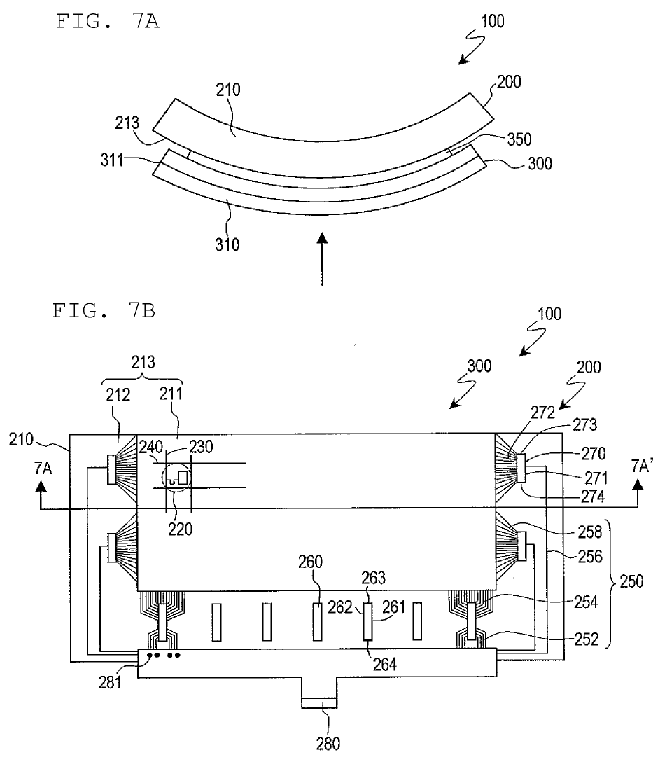

In the above description, the first and second glass substrates 210 and 310 are preferably curved in the lateral direction, and the scanning line driving elements 260 and the signal line driving elements 270 are preferably vertically positioned; however, the present invention is not limited thereto. As shown in FIG. 6, the scanning line driving elements 260 and the signal line driving elements 270 may be laterally positioned on first and second glass substrates 210 and 310 which are curved in the vertical direction. Thus, on the first glass substrate 210, which is curved with respect to a bending axis parallel to the scanning lines 240 in a direction that the signal lines 230 extend, i.e., the vertical direction, the longer sides 261, 262 of the signal line driving elements 260 and the longer sides 271, 272 of the scanning line driving elements 270 are disposed parallel or substantially parallel to the direction that the scanning lines 240 extend; as a result, the signal line driving elements 260 and the scanning line driving elements 270 are both unlikely to be detached from the first glass substrate 210, and the electrical connection of the signal line driving elements 260 and the scanning line driving elements 270 is ensured.

In the above description, the signal line driving elements 260 and the scanning line driving elements 270 preferably are mounted on the first glass substrate 210 via an anisotropic electrically-conductive layer (not shown); however, the present invention is not limited thereto. The signal line driving elements 260 and the scanning line driving elements 270 may be mounted via solder.

In the display device 100 shown in FIG. 1C, the plurality of signal line driving elements 260 and scanning line driving elements 270 are preferably mounted on the first glass substrate 210; however, the present invention is not limited thereto. There may be one signal line driving element 260 and one scanning line driving element 270.

In the above description, an instrument panel of an automotive vehicle is preferably illustrated as an application of a display device having a curved shape; however, the present invention is not limited thereto. For example, a circuit for receiving a television broadcast may be provided for a display device having a curved shape, and this display device may be utilized in a large-size television set. In this case, too, reflection glare of external light will be suppressed, and the viewer will feel surrounded by the concave-shaped display surface, thus being able to view a realistic video.

In the above description, the display surface is preferably curved in a concave shape toward the viewer; however, the present invention is not limited thereto. As shown in FIG. 7A, the display surface may be curved in the lateral direction, so as to present a convex shape toward the viewer. In this display device 100, as shown in FIG. 7A, the principal surface 213 of the first glass substrate 210 is curved in a convex shape; the principal surface 311 of the second glass substrate 310 is curved in a concave shape; and as shown in FIG. 7B, the signal line driving elements 260 are vertically positioned.

In the above description, the display device preferably is a liquid crystal display device; however, the present invention is not limited thereto. The display device may be any arbitrary display device, such as an organic EL display device, a plasma display device, or an SED display device. In the case where the display device is an organic EL display device, the display device does not need to include a counter substrate, but a display medium layer (i.e., an organic EL layer) may be disposed on a principal surface of an active matrix substrate.

According to various preferred embodiments of the present invention, a display device which is suitably used for an instrument panel can be provided. This instrument panel is suitably used for various types of automotive vehicles, e.g., a car, a motorbike, a bus, a truck, a tractor, an airplane, a motor boat, a vehicle for civil engineering use, a train, or the like. Moreover, according to various preferred embodiments of the present invention, a display device which is capable of displaying a realistic video can be provided.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-10. (canceled)

11. A display device comprising:
an active matrix substrate; and
a display medium layer disposed on a principal surface of the active matrix substrate; wherein
the active matrix substrate includes:
a glass substrate having a principal surface which includes a displaying region and a terminal region;
a plurality of circuit elements provided in the displaying region of the glass substrate;
a plurality of signal lines and a plurality of scanning lines connected to the plurality of circuit elements;
at least one signal line driving element mounted in the terminal region of the glass substrate to supply a data signal to the plurality of signal lines; and
at least one scanning line driving element mounted in the terminal region of the glass substrate to supply a gate signal to the plurality of scanning lines;
the glass substrate is curved; and
when the at least one signal line driving element and the at least one scanning line driving element are each viewed from a normal direction of the principal surface of the glass substrate, the at least one signal line driving element and the at least one scanning line driving element each have a rectangular or substantially rectangular shape with two longer sides and two shorter sides, the at least one signal line driving element and the at least one scanning line driving element each being mounted so that the longer sides thereof are parallel or substantially parallel to one another.

12. The display device of claim 11, wherein the glass substrate is curved in a direction which is perpendicular or substantially perpendicular to each longer side of the at least one signal line driving element.

13. The display device of claim 11, wherein the longer sides of the at least one signal line driving element are parallel or substantially parallel, or perpendicular or substantially perpendicular, to a direction in which the plurality of signal lines extend.

14. The display device of claim 11, wherein the principal surface of the glass substrate is curved in a concave shape.

15. The display device of claim 11, wherein the principal surface of the glass substrate is curved in a convex shape.

16. The display device of claim 11, wherein the at least one signal line driving element and the at least one scanning line driving element are each mounted via an anisotropic electrically-conductive layer.

17. The display device of claim 11, wherein
the active matrix substrate further includes a plurality of substrate lines provided in the terminal region of the glass substrate;
input bumps and output bumps are provided on the at least one signal line driving element; and
the plurality of substrate lines include a plurality of input substrate lines electrically connected to the input bumps of the at least one signal line driving element and a plurality of output substrate lines electrically connected to the plurality of signal lines and the output bumps of the at least one signal line driving element, the output substrate line or lines corresponding to the at least one signal line driving element being disposed so as to be closer to the displaying region than are the input substrate lines.

18. The display device of claim 11, further comprising a counter substrate opposing the active matrix substrate via the display medium layer, wherein the display medium layer is a liquid crystal layer.

19. The display device of claim 11, further comprising a circuit arranged to receive a television broadcast.

20. An automotive vehicle comprising the display device of claim 11 which defines at least a portion of an instrument panel.
